(19) United States
(12) Patent Application Publication
(10) Pub. No.: US 2003/0124253 A1
(43) Pub. Date: Jul. 3, 2003

(54) Wire coloring method and a wire coloring apparatus

(75) Inventors: Takeshi Kamata, Shizuoka (JP); Shigeharu Suzuki, Shizuoka (JP); Keigo Sugimura, Shizuoka (JP)

Correspondence Address: ARMSTRONG,WESTERMAN & HATTORI, LLP, 1725 K STREET, NW, SUITE 1000, WASHINGTON, DC, 20006, US

(73) Assignee: YAZAKI CORPORATION, Tokyo (JP)

(21) Appl. No.: 10/281,258

(22) Filed: Oct. 28, 2002

(30) Foreign Application Priority Data
Dec. 28, 2001 (JP) 2001-400642

(51) Int. Cl. B05D 5/00

(52) U.S. Cl. 427/256; 118/300; 118/689

(57) ABSTRACT

A wire coloring method and a wire coloring apparatus are provided. The wire coloring apparatus 1 has a coloring portion 10, a colorant-supplying portion 11, and a control unit 12. The coloring portion 10 has a mixing tank 23. The mixing tank 23 mixes first to fourth colorants B,R,Y,BL supplied from the colorant-supplying portion 11. The coloring portion 10 colors an outer surface 5a of an electric wire 3 with the mixed colorant in a mixing tank 23. The colorant-supplying portion 11 has a first to fourth adjusting valves 26,27,28,29 to increase and decrease flow rates of the first to fourth colorants B,R,Y,BL to the mixing tank 23. The control unit 12 controls opening ratios of the first to fourth adjusting valves 26,27,28,29.

### BACKGROUND OF THE INVENTION

1. Field of the Invention

The present invention relates to a wire coloring method and a wire coloring apparatus for coloring an electric wire, used for a wiring harness arranged on a motor vehicle, in a specified color.

2. Description of the Related Art

Various kinds of electronic equipment are carried on a motor vehicle. Therefore, the wiring harness is arranged on the motor vehicle so that electric power from a power source and control signals from a computer can be supplied to the electronic equipment. The wiring harness has electric wires 106 (FIG. 5) and connectors attached to end portions of the electric wires 106.

The electric wire 106 has a conductive core wire 105 (FIG. 5) and a covering portion of insulative synthetic resin, which covering portion covers the core wire 105. That is, the electric wire 106 is a covered wire. The electric wire 106 has been manufactured by a wire manufacturing apparatus 100 shown in FIG. 5. The wire manufacturing apparatus 100 of FIG. 5 has a supply unit 101, a pushing-covering unit 102, a cooling water tank 103, and a winding unit 104.

The electric wire 106 or a core wire thereof is successively moved through the supply unit 101, the pushing-covering unit 102, the cooling water tank 103, and the winding unit 104. The wire manufacturing apparatus 100 has pulleys 107 for moving the core wire 105 or the electric wire 106.

The supply unit 101 supplies the core wire 105. The pushing-covering unit 102 pushes the insulative synthetic resin out so that the covering portion is formed around the core wire 105 supplied from the supply unit 101. The cooling water tank 103 cools the covering portion. The winding unit 104 cuts off the electric wire 106 in a predetermined length and winds the electric wire 106 around a drum for shipment. Like this, the electric wire 106 is manufactured by the wire manufacturing apparatus 100.

A connector has a conductive terminal fitting and an insulative connector housing. The terminal fitting is attached to an end portion of the electric wire 106 and is electrically-connected with the core wire 105 of the electric wire 106. The connector housing is formed in a box-shape and accommodates the terminal fittings.

When the wiring harness is manufactured or assembled, the electric wire 106 is firstly cut in a fixed length, and the terminal fitting is attached to the end portion of the electric wire 106. The electric wires 106 are connected as the need arises. Subsequently, the terminal fitting is inserted into the connector housing. Like this, the above-described wiring harness is manufactured or assembled.

With regard to the electric wire 106 of the wiring harness, the thickness of the core wire 105, material (for example, from viewpoint of heat-resistance) of the covering portion, and service conditions should be distinguished. Here, the service conditions mean systems such as an air-bag system, an antilock brake system, a vehicle-speed information system and a power transmission system in which the electric wires 106 are used.

The electric wires 106 of the wiring harness are variously colored and marked for distinguishing the above systems. Then, in the wire manufacturing apparatus 100 shown in FIG. 5, a colorant is put in the synthetic resin to form the covering portion at the pushing-covering unit 102. The synthetic resin and the colorant are mixed in the pushing-covering unit 102, thereby coloring the synthetic resin with the colorant. The synthetic resin in the same color as that of the colorant is pushed out around the core wire 105. Like this, the covering portion of the electric wire 106 has been colored.

On the other hand, various demands arise from users for the motor vehicle. That is, the motor vehicle is expected to have various kinds of electronic equipment. Consequently, the wiring harness sometimes consists of not less than 100 kinds of the electric wires 106. Therefore, the wire manufacturing apparatus 100 is required to change the color of the covering portion of the electric wire.

With respect to the above prior art wire manufacturing apparatus 100, however, when the color of the covering portion of the electric wire 106 is changed, the pushing-covering unit 102 is once stopped in order to change the colorant to be mixed in the synthetic resin. In this case, when the electric wires 106 of various colors are manufactured, the pushing-covering unit 102 has to be frequently stopped, which lowers the producibility of the electric wire 106. Consequently, the cost of the electric wire 106 is enhanced.

The wire manufacturing apparatus 100 has been sometimes installed for each electric wire 106 having different color, thereby enhancing the cost of the electric wire 106.

Further, in the wire manufacturing apparatus 100, the colorants are required by the same number as that of the colors of the electric wires. Therefore, the trouble to order and stock-control the various kinds of colorants increases, and therefore the man-hour to manufacture the electric wire 106 increases. Further, the cost to convey and store the colorants increases. Therefore, the cost of the electric wire 106 is further enhanced.

### SUMMARY OF THE INVENTION

In view of the foregoing, an object of the present invention is to provide a wire coloring method and a wire coloring apparatus, wherein an electric wire in various colors can be easily manufactured, while reducing the cost of the electric wire.

In order to achieve the above object, as a first aspect of the present invention, a wire coloring method comprises the steps of: mixing colorants having respective colors different from each other; and coloring an outer surface of a non-colored electric wire, wherein a color for the outer surface of the electric wire is changed by changing a mixing ratio of the colorants.

As a second aspect of the present invention, a wire coloring method comprises the steps of: mixing a first colorant of blue, a second colorant of red, a third colorant of yellow, and a fourth colorant of black; and coloring an outer surface of a non-colored electric wire, wherein a color for the outer surface of the electric wire is changed by changing a mixing ratio of the first to fourth colorants.

As a thirst aspect of the present invention, a wire coloring apparatus comprises: a coloring portion to color an outer surface of an electric wire; receiving portions to receive respective colorants having respective colors different from each other and to supply the colorants to the coloring portion; a plurality of increasing-and-decreasing means to increase and decrease the respective colorants supplied from the respective receiving portions to the coloring portion; and a controlling means to control the plurality of increasing-and-decreasing means so as to increase and decrease the respective colorants supplied to the coloring portion, wherein the coloring portion mixes the colorants and colors the outer surface of the non-colored electric wire, and the controlling means changes a color for the outer surface of the electric wire by changing a mixing ratio of the colorants.

As a fourth aspect of the present invention, a wire coloring apparatus comprises: a coloring portion to color an outer surface of an electric wire; a first receiving portion to receive a first colorant of blue and to supply the first colorant to the coloring portion; a second receiving portion to receive a second colorant of red and to supply the second colorant to the coloring portion; a third receiving portion to receive a third colorant of yellow and to supply the third colorant to the coloring portion; a fourth receiving portion to receive a fourth colorant of black and to supply the fourth colorant to the coloring portion; a first increasing-and-decreasing means to increase and decrease a first colorant supplied from the first receiving portion to the coloring portion; a second increasing-and-decreasing means to increase and decrease a second colorant supplied from the second receiving portion to the coloring portion; a third increasing-and-decreasing means to increase and decrease a third colorant supplied from the third receiving portion to the coloring portion; a fourth increasing-and-decreasing means to increase and decrease a fourth colorant supplied from the fourth receiving portion to the coloring portion; and a controlling means to control the first to fourth increasing-and-decreasing means so as to increase and decrease the respective colorants supplied to the coloring portion, wherein the coloring portion mixes the first to fourth colorants and colors the outer surface of the non-colored electric wire, and the controlling means changes a color for the outer surface of the electric wire by changing a mixing ratio of the first to fourth colorants.

As a fifth aspect of the present invention, a wire coloring method comprises the step of: coloring an outer surface of a non-colored electric wire by dyeing the outer surface of the electric wire in turn with coloring liquids having respective colors different from each other, wherein a color for the outer surface of the electric wire is changed by increasing and decreasing each of the coloring liquids.

As a sixth aspect of the present invention, a wire coloring method comprises the step of: coloring an outer surface of a non-colored electric wire by dyeing the outer surface of the electric wire with a first coloring liquid of blue, a second coloring liquid of red, a third coloring liquid of yellow, and a fourth coloring liquid of black, wherein a color for the outer surface of the electric wire is changed by increasing and decreasing each of the first to fourth coloring liquids.

As a seventh aspect of the present invention, a wire coloring apparatus comprises: coloring portions to dye an outer surface of an electric wire with respective coloring liquids having respective colors different from each other; a plurality of increasing-and-decreasing means to increase and decrease the respective coloring liquids, to dye the outer surface of the electric wire, to the respective coloring portions; and a controlling means to control the plurality of increasing-and-decreasing means so as to increase and decrease the respective coloring liquids to the respective coloring portions, wherein an outer surface of a non-colored electric wire is colored by dyeing the outer surface of the electric wire in turn with the coloring liquids having respective colors different from each other, and a color for the outer surface of the electric wire is changed by increasing and decreasing each of the coloring liquids by the controlling means.

As an eighth aspect of the present invention, a wire coloring apparatus comprises: a first coloring portion to dye an outer surface of an electric wire with a first coloring liquid of blue; a second coloring portion to dye the outer surface of the electric wire with a second coloring liquid of red; a third coloring portion to dye the outer surface of the electric wire with a third coloring liquid of yellow; a fourth coloring portion to dye the outer surface of the electric wire with a fourth coloring liquid of black; a first increasing-and-decreasing means to increase and decrease the first coloring liquid, to dye the outer surface of the electric wire, to the first coloring portion; a second increasing-and-decreasing means to increase and decrease the second coloring liquid, to dye the outer surface of the electric wire, to the second coloring portion; a third increasing-and-decreasing means to increase and decrease the third coloring liquid, to dye the outer surface of the electric wire, to the third coloring portion; a fourth increasing-and-decreasing means to increase and decrease the fourth coloring liquid, to dye the outer surface of the electric wire, to the fourth coloring portion; and a controlling means to control the first to fourth increasing-and-decreasing means so as to increase and decrease the respective coloring liquids to the first to fourth coloring portions, wherein an outer surface of a non-colored electric wire is colored by dyeing the outer surface of the electric wire with the first to fourth coloring liquids, and a color for the outer surface of the electric wire is changed by increasing and decreasing each of the first to fourth coloring liquids by the controlling means.

As a ninth aspect of the present invention, based on the eighth aspect, the electric wire is moved in its longitudinal direction, the first to fourth coloring portions are arranged in the moving direction of the electric wire, and the coloring portions color the outer surface of the electric wire being moving in turn.

Here, the non-colored electric wire has the covering portion of synthetic resin in which colorant is not put. That is, the covering portion of the non-colored electric wire has a color of synthetic resin itself.

In this specification, “to color the electric wire” means to color the outer surface of the covering portion of the electric wire with a coloring liquid or a paint. In the coloring liquid, the dye is dissolved or dispersed in the solvent. In the paint, the pigment is dispersed in the dispersion liquid. Therefore, when the outer surface of the covering portion is colored by the coloring liquid, the dye soaks into in the covering portion, and when the outer surface of the covering portion is colored by the paint, the pigment adheres to the outer surface without soaking into the covering portion. That is, “to color the outer surface of the electric wire” in the present specification means to dye the outer surface of the covering portion of the electric wire with the dye and also to paint the pigment on the outer surface of the covering portion of the electric wire. And also,. “to color the outer surface of the electric wire” in this specification includes to color or dye a colorant-containing ultraviolet curing resin or the like.

The solvent and the dispersion liquid should have an affinity for synthetic resin forming the covering portion of the electric wire so that the dye securely soaks into the covering portion of the electric wire and the pigment securely adheres to the outer surface of the covering portion of the electric wire. Here, the colorant in this specification means the coloring liquid and the paint.

According to the above-described structures of the present invention, the following advantages are provided.

(1) The colorants having respective colors different from each other are mixed, and the color for the outer surface of the electric wire is changed by changing the mixing ratio of the colorants. Therefore, the outer surface of the electric wire can be colored in every color only by preparing a small number of colorants. Therefore, the facilities cost for coloring the electric wire can be reduced. The color for the outer surface of the electric wire can be easily changed only by changing the mixing ratio of the colorants. Therefore, the manufacturing efficiency of the electric wire can be improved.

Further, because the outer surface of the electric wire can be colored in every color only by preparing a small number of colorants, the trouble to order and stock-control the colorants can be reduced, and the cost to convey and store the colorants can be reduced. Therefore, the outer surface of the electric wire can be variously colored easily, and the cost of the electric wire can be reduced.

(2) The first colorant of blue, the second colorant of red, the third colorant of yellow, and the fourth colorant of black are mixed, and the color for the outer surface of the electric wire is changed by changing the mixing ratio of the colorants. Therefore, the outer surface of the electric wire can be colored in every color only by preparing the four colorants. Therefore, the facilities cost for coloring the electric wire can be reduced.

The color for the outer surface of the electric wire can be easily changed only by changing the mixing ratio of the four colorants. Therefore, the manufacturing efficiency of the electric wire can be improved.

Further, because the outer surface of the electric wire can be colored in every color only by preparing the four colorants, the trouble to order and stock-control the colorants can be reduced, and the cost to convey and store the colorants can be reduced. Therefore, the outer surface of the electric wire can be variously colored easily, and the cost of the electric wire can be reduced.

(3) The colorants having respective colors different from each other are mixed, and the color for the outer surface of the electric wire is changed by changing the mixing ratio of the colorants by the controlling means. Therefore, the outer surface of the electric wire can be colored in every color only by preparing a small number of colorants. Therefore, the facilities cost for coloring the electric wire can be reduced. The color for the outer surface of the electric wire can be easily changed only by changing the mixing ratio of the colorants. Therefore, the manufacturing efficiency of the electric wire can be improved.

Further, because the outer surface of the electric wire can be colored in every color only by preparing a small number of colorants, the trouble to order and stock-control the colorants can be reduced, and the cost to convey and store the colorants can be reduced. Therefore, the outer surface of the electric wire can be variously colored easily, and the cost of the electric wire can be reduced.

(4) The first colorant of blue, the second colorant of red, the third colorant of yellow, and the fourth colorant of black are mixed, and the color for the outer surface of the electric wire is changed by changing the mixing ratio of the colorants by the controlling means. Therefore, the outer surface of the electric wire can be colored in every color only by preparing the four colorants. Therefore, the facilities cost for coloring the electric wire can be reduced.

The color for the outer surface of the electric wire can be easily changed only by changing the mixing ratio of the four colorants. Therefore, the manufacturing efficiency of the electric wire can be improved.

Further, because the outer surface of the electric wire can be colored in every color only by preparing the four colorants, the trouble to order and stock-control the colorants can be reduced, and the cost to convey and store the colorants can be reduced. Therefore, the outer surface of the electric wire can be variously colored easily, and the cost of the electric wire can be reduced.

(5) The outer surface of the electric wire is dyed in turn with the coloring liquids having respective colors different from each other. The color for the outer surface of the electric wire is changed by changing the amount of each of the coloring liquids. Therefore, the outer surface of the electric wire can be colored in every color only by preparing a small number of coloring liquids. Therefore, the facilities cost for coloring the electric wire can be reduced. Because the color for the outer surface of the electric wire can be easily changed only by changing the amount of each of the coloring liquids, the manufacturing efficiency of the electric wire can be improved.

Further, because the outer surface of the electric wire can be colored in every color only by preparing a small number of coloring liquids, the trouble to order and stock-control the coloring liquids can be reduced, and the cost to convey and store the coloring liquids can be reduced. Therefore, the outer surface of the electric wire can be variously colored easily, and the cost of the electric wire can be reduced.

The outer surface of the electric wire is dyed (colored) in turn with the coloring liquids. That is, it is not necessary to dye (color) the electric wire in the specified color at a time. Therefore, the electric wire can be dyed (colored) in the specified color by dying it with the coloring liquids one by one with a time interval of, for example, several hours or several days. Therefore, limitation of the process for coloring the electric wire can be relaxed, thereby increasing the degree of freedom of the coloring process.

(6) The outer surface of the electric wire is dyed in turn with the first coloring liquid of blue, the second coloring liquid of red, the third coloring liquid of yellow, and the fourth coloring liquid of black. The color for the outer surface of the electric wire is changed by changing the amount of each of the coloring liquids. Therefore, the outer surface of the electric wire can be colored in every color only by preparing the four coloring liquids. Therefore, the facilities cost for coloring the electric wire can be reduced.

The color for the outer surface of the electric wire can be easily changed only by changing the amount of each of the four coloring liquids. Therefore, the manufacturing efficiency of the electric wire can be improved.

Further, because the outer surface of the electric wire can be colored in every color only by preparing the four coloring liquids, the trouble to order and stock-control the coloring liquids can be reduced, and the cost to convey and store the coloring liquids can be reduced. Therefore, the outer surface of the electric wire can be variously colored easily, and the cost of the electric wire can be reduced.

The outer surface of the electric wire is dyed (colored) in turn with the four coloring liquids. That is, it is not necessary to dye (color) the electric wire in the specified color at a time. Therefore, the electric wire can be dyed (colored) in the specified color by dying it with the coloring liquids one by one with a time interval of, for example, several hours or several days. Therefore, limitation of the process for coloring the electric wire can be relaxed, thereby increasing the degree of freedom of the coloring process.

(7) The outer surface of the electric wire is dyed in turn with the coloring liquids having respective colors different from each other. The color for the outer surface of the electric wire is changed by changing the amount of each of the coloring liquids by the controlling means. Therefore, the outer surface of the electric wire can be colored in every color only by preparing a small number of coloring liquids. Therefore, the facilities cost for coloring the electric wire can be reduced. Because the color for the outer surface of the electric wire can be easily changed only by changing the amount of each of the coloring liquids, the manufacturing efficiency of the electric wire can be improved.

Further, because the outer surface of the electric wire can be colored in every color only by preparing a small number of coloring liquids, the trouble to order and stock-control the coloring liquids can be reduced, and the cost to convey and store the coloring liquids can be reduced. Therefore, the outer surface of the electric wire can be variously colored easily, and the cost of the electric wire can be reduced.

The outer surface of the electric wire is dyed (colored) in turn with the coloring liquids. That is, it is not necessary to dye (color) the electric wire in the specified color at a time. Therefore, the electric wire can be dyed (colored) in the specified color by dying it with the coloring liquids one by one with a time interval of, for example, several hours or several days. Therefore, limitation of the process for coloring the electric wire can be relaxed, thereby increasing the degree of freedom of the coloring process.

(8) The outer surface of the electric wire is dyed with the first coloring liquid of blue, the second coloring liquid of red, the third coloring liquid of yellow, and the fourth coloring liquid of black. The color for the outer surface of the electric wire is changed by changing the amount of each of the coloring liquids by the controlling means. Therefore, the outer surface of the electric wire can be colored in every color only by preparing the four coloring liquids. Therefore, the facilities cost for coloring the electric wire can be reduced.

The color for the outer surface of the electric wire can be easily changed only by changing the amount of each of the four coloring liquids. Therefore, the manufacturing efficiency of the electric wire can be improved.

Further, because the outer surface of the electric wire can be colored in every color only by preparing the four coloring liquids, the trouble to order and stock-control the coloring liquids can be reduced, and the cost to convey and store the coloring liquids can be reduced. Therefore, the outer surface of the electric wire can be variously colored easily, and the cost of the electric wire can be reduced.

The outer surface of the electric wire is dyed (colored) in turn with the four coloring liquids. That is, it is not necessary to dye (color) the electric wire in the specified color at a time. Therefore, the electric wire can be dyed (colored) in the specified color by dying it with the coloring liquids one by one with a time interval of, for example, several hours or several days. Therefore, limitation of the process for coloring the electric wire can be relaxed, thereby increasing the degree of freedom of the coloring process.

(9) The first to fourth coloring portions are lined up along the moving direction of the electric wire. Therefore, the outer surface of the electric wire can be securely dyed successively with the first coloring liquid of blue, the second coloring liquid of red, the third coloring liquid of yellow, and the fourth coloring liquid of black. The outer surface of the electric wire can be securely colored in every color.

The above and other objects and features of the present invention will become more apparent from the following description taken in conjunction with the accompanying drawings.

### BRIEF DESCRIPTION OF THE DRAWINGS

FIG. 1 is an explanatory illustration showing the first embodiment of the inventive wire coloring apparatus.

FIG. 2 is a perspective view of an electric wire whose outer surface has been colored by the wire coloring apparatus shown in FIG. 1.

FIG. 3A is a perspective view of a non-colored electric wire which is not colored by the wire coloring apparatus of FIG. 1.

FIG. 3B is a perspective view of an electric wire which has been colored by the wire coloring apparatus of FIG. 1.

FIG. 4 is an explanatory illustration showing the second embodiment of the inventive wire coloring apparatus.

FIG. 5 is an explanatory illustration showing the structure of a prior art wire manufacturing apparatus.

### DESCRIPTION OF THE PREFERRED EMBODIMENT(S)

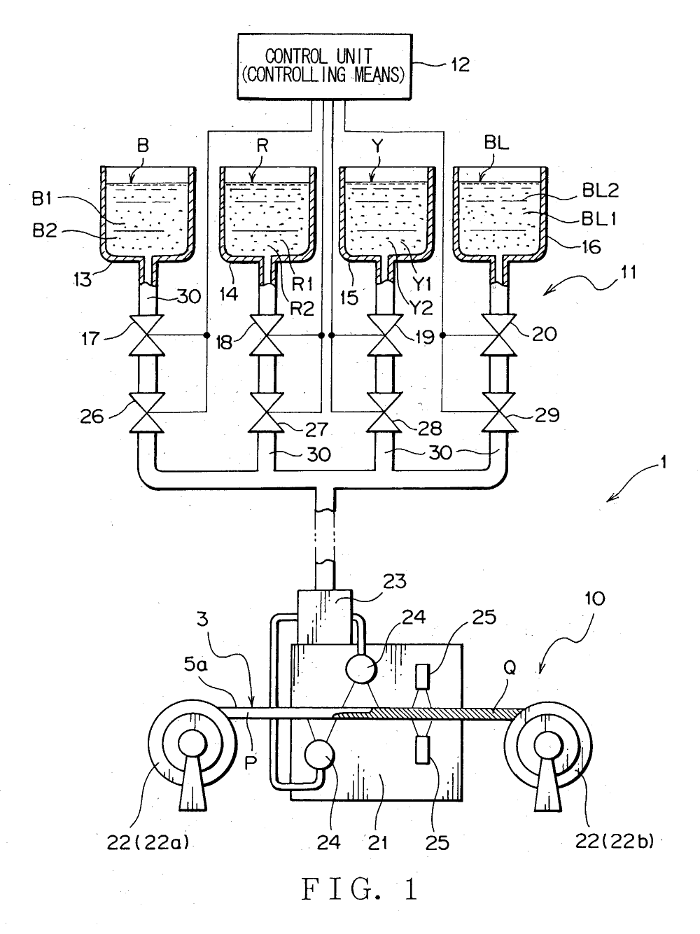

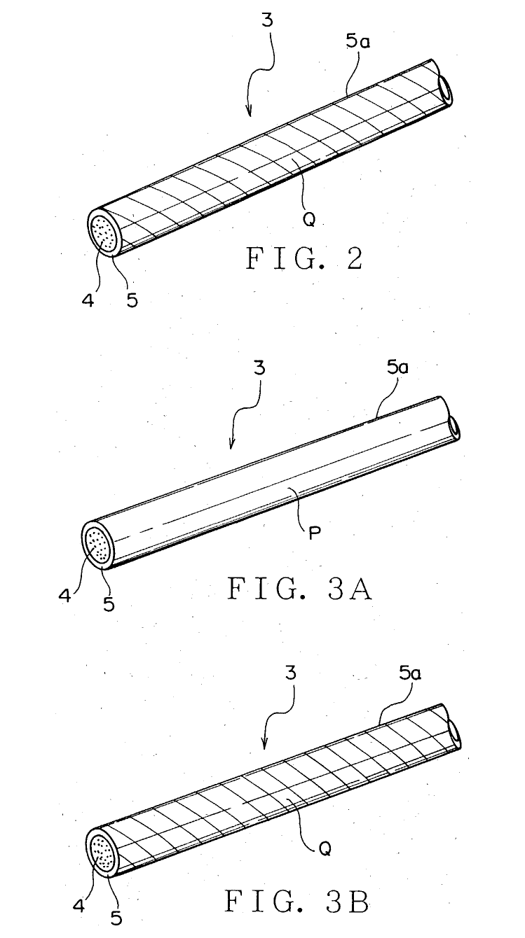

A first embodiment of the invention wire coloring apparatus will now be described in further detail with reference to FIG. 1-FIG. 3. The wire coloring apparatus 1 (FIG. l) is an apparatus to color an electric wire 3 shown in FIG. 2.

The electric wires 3 form a wiring harness to be arranged on a motor vehicle. The electric wire 3 has a conductive core wire 4 and an insulative covering portion 5 as shown in FIG. 2. The core wire 4 is formed by stranding or twisting conductors. The conductors forming the core wire 4 are made of conductive metal. Otherwise, the core wire 4 can be a single conductor.

The covering portion 5 is made of synthetic resin such as polyvinylchloride (PVC) for example. The covering portion 5 covers the core wire 4. An outer surface 5a of the covering portion 5 of the electric wire 3 is colored in a specified color Q.

The electric wire 3 are bundled and connectors are attached to end portions thereof thereby to form the wiring harness. The connectors are connected with mating connectors of various electronic equipment of a motor vehicle for transmitting signals or electric powers.

The wire coloring apparatus 1 colors the outer surface 5a of the non-colored electric wire 3 in a color Q which is different from a color P (FIG. 3A) of synthetic resin forming the covering portion 5. In this specification, “non-colored” means a state of synthetic resin to which the colorant is not mixed. The non-colored covering portion of the electric wire 3 has the color P of synthetic resin itself.

In this specification, “to color the electric wire” means to color the outer surface 5a of the covering portion 5 of the electric wire 3 with a coloring liquid or a paint. In the coloring liquid, the dye is dissolved or dispersed in the solvent. In the paint, the pigment is dispersed in the dispersion liquid.

Therefore, when the outer surface 5a of the covering portion 5 is colored by the coloring liquid, the dye soaks into in the covering portion 5, and when the outer surface 5a of the covering portion 5 is colored by the paint, the pigment adheres to the outer surface 5a without soaking into the covering portion 5. That is, “to color the outer surface of the electric wire” in the present specification means to dye the outer surface of the covering portion of the electric wire with the dye and also to paint the pigment on the outer surface of the covering portion of the electric wire. And also, “to color the outer surface of the electric wire” in this specification includes to color or dye a colorant-containing ultraviolet curing resin or the like. To color the covering portion 5 of the electric wire 3 includes to paint the covering portion 5 of the electric wire 3 and also to dye the covering portion 5 of the electric wire 3.

The solvent and the dispersion liquid should have an affinity for synthetic resin forming the covering portion of the electric wire so that the dye securely soaks into the covering portion of the electric wire and the pigment securely adheres to the outer surface of the covering portion of the electric wire. Here, the colorant means, or includes, the coloring liquid and the paint.

The wire coloring apparatus 1 has a coloring portion 10 to color the outer surface 5a of the electric wire 3, a colorant-supplying portion 11 to supply the first to fourth colorants B,R,Y,BL (described later), and a control unit 12 as a controlling means, as shown in FIG. 1.

The coloring portion 10 has a coloring portion body 21, a pair of rollers 22, a mixing tank 23, sprayers 24 and driers 25. The pair of rollers 22 are arranged with an interval with each other so that the electric wire 3 can be moved therebetween in a longitudinal direction of the electric wire 3. The left side roller 22(22a) in FIG. 1 is positioned upstream of a moving direction of the electric wire 3. The right side roller 22(22b) in FIG. 1 is positioned downstream of the moving direction of the electric wire 3.

The mixing tank 23 is formed in a box-shape and attached to the above coloring portion body 21. The first to fourth colorants B,R,Y,BL are supplied to the mixing tank 23 from the colorant-supplying portion 11. The mixing tank 23 receives the first to fourth colorants B,R,Y,BL and mixes them. The mixing tank 23 supplies the mixed colorant to the sprayer 24.

In the illustrated embodiment, a pair of sprayers 24 are provided. The sprayer 24 sprays the mixed colorant on the electric wire 3 traveling between rollers 22a,22b. The sprayers 24 color the outer surface 5a of the electric wire 3 with the paint or with the coloring liquid over the whole periphery of the electric wire 3. That is, the sprayers 24 color the outer surface 5a of the electric wire 3 with the colorant. The sprayers 24 color the outer surface 5a in the color Q, which is different from the color P of synthetic resin, over the whole periphery of the electric wire 3.

The driers 25 are arranged downstream of the sprayers 24 in the moving direction of the electric wire 3. The drier 25 dries the paint or the coloring liquid sprayed on the outer surface 5a of the electric wire 3 by the sprayer 24.

The colorant-supplying portion 11 has a first receiving tank 13 as a first receiving portion, a second receiving tank 14 as a second receiving portion, a third receiving tank 15 as a third receiving portion, a fourth receiving tank 16 as a fourth receiving portion, a first to fourth opening-and-closing valves 17,18,19,20, a first adjusting valve 26 as a first increasing-and-decreasing means, a second adjusting valve 27 as a second increasing-and-decreasing means, a third adjusting valve 28 as a third increasing-and-decreasing means, and a fourth adjusting valve 29 as a fourth increasing-and-decreasing means.

The first receiving tank 13 is formed in a box-shape and receives the first colorant B of blue. The first colorant B is the above-described coloring liquid or the paint. That is, the first colorant B is made up of the solvent B2 and the blue dye B1 dissolved therein, or of the dispersion liquid B2 and the blue pigment B1 dispersed therein. Here, the dye and the pigment are shown at the same reference B1, and the solvent and the dispersion liquid are shown at the same reference B2.

The second receiving tank 14 is formed in a box-shape and receives the second colorant R of red. The second colorant R is the above-described coloring liquid or the paint. That is, the second colorant R is made up of the solvent R2 and the red dye R1 dissolved therein, or of the dispersion liquid R2 and the red pigment RI dispersed therein. Here, the dye and the pigment are shown at the same reference R1, and the solvent and the dispersion liquid are shown at the same reference R2.

The third receiving tank 15 is formed in a box-shape and receives the third colorant Y of yellow. The third colorant Y-is the above-described coloring liquid or the paint. That is, the third colorant Y is made up of the solvent Y2 and the yellow dye Y1 dissolved therein, or of the dispersion liquid Y2 and the yellow pigment Y1 dispersed therein. Here, the dye and the pigment are shown at the same reference Y1, and the solvent and the dispersion liquid are shown at the same reference Y2.

The fourth receiving tank 16 is formed in a box-shape and receives the fourth colorant BL of black. The fourth colorant BL is the above-described coloring liquid or the paint. That is, the fourth colorant BL is made up of the solvent BL2 and the black dye BL1 dissolved therein, or of the dispersion liquid BL2 and the black pigment BL1 dispersed therein. Here, the dye and the pigment are shown at the same reference BL1, and the solvent and the dispersion liquid are shown at the same reference BL2.

The first colorant B of blue in the present specification means that the hue is blue, regardless of the lightness or the chroma (brightness). That is, the first colorant B of blue in the present specification means that the hue is blue, regardless of light blue or dark blue, or bright blue or dim blue.

The second colorant R of red in the present specification means that the hue is red, regardless of the lightness or the chroma (brightness). That is, the second colorant R of red in the present specification means that the hue is red, regardless of light red or dark red, or bright red or dim red.

The third colorant Y of yellow in the present specification means that the hue is yellow, regardless of the lightness or the chroma (brightness). That is, the third colorant Y of yellow in the present specification means that the hue is yellow, regardless of light yellow or dark yellow, or bright yellow or dim yellow.

The fourth colorant BL of black in the present specification means that the hue is black, regardless of the lightness. That is, the fourth colorant BL of black in the present specification means that the hue is black, regardless of light black or dark black.

Here, the above hue means the tinge or the tint. The lightness is the degree of luminosity. The chroma is the degree of brightness. A piping 30 is connected to the first to fourth receiving tanks 13,14,15,16. The piping 30 is also connected to the mixing tank 23. The piping 30 leads the first to fourth colorants B,R,Y,BL in the respective first to fourth receiving tanks 13,14,15,16 to the mixing tank 23. Further, a non-shown solvent source is connected to the piping 30. This solvent source is connected to the mixing tank 23 through the piping 30. The solvent source supplies a solvent, which can remove the colorants B,R,Y,BL of the mixing tank 23, to the mixing tank 23.

The first to fourth opening-and-closing valves 17,18,19,20 are attached to the piping 30. When the first opening-and-closing valve 17 is open, the first colorant B in the first receiving tank 13 is supplied to the mixing tank 23. When the first opening-and-closing valve 17 is closed, the supply of the first colorant B in the first receiving tank 13 to the mixing tank 23 stops. When the second opening-and-closing valve 18 is open, the second colorant R in the second receiving tank 14 is supplied to the mixing tank 23. When the second opening-and-closing valve 18 is closed, the supply of the second colorant R in the second receiving tank 14 to the mixing tank 23 stops.

When the third opening-and-closing valve 19 is open, the third colorant Y in the third receiving tank 15 is supplied to the mixing tank 23. When the third opening-and-closing valve 19 is closed, the supply of the third colorant Y in the third receiving tank 23 to the mixing tank 23 stops. When the fourth opening-and-closing valve 20 is open, the fourth colorant BL in the fourth receiving tank 16 is supplied to the mixing tank 23. When the fourth opening-and-closing valve 20 is closed, the supply of the fourth colorant BL in the fourth receiving tank 16 to the mixing tank 23 stops.

The first to fourth adjusting valves 26,27,28,29 are attached to the piping 30. The first adjusting valve 26 increases and decreases a flow rate of the first colorant B from the first receiving tank 13 to the mixing tank 23 by changing its opening ratio. Of course, the flow rate (i.e. the supply rate) increases when the opening ratio is large, and the flow rate decreases when the opening ratio is small. The second adjusting valve 27 increases and decreases a flow rate of the second colorant R from the second receiving tank 14 to the mixing tank 23 by changing its opening ratio. Of course, the flow rate (i.e. the supply rate) increases when the opening ratio is large, and the flow rate decreases when the opening ratio is small.

The third adjusting valve 28 increases and decreases a flow rate of the third colorant Y from the third receiving tank 15 to the mixing tank 23 by changing its opening ratio. Of course, the flow rate (i.e. the supply rate) increases when the opening ratio is large, and the flow rate decreases when the opening ratio is small. The fourth adjusting valve 29 increases and decreases a flow rate of the fourth colorant BL from the fourth receiving tank 16 to the mixing tank 23 by changing its opening ratio. Of course, the flow rate (i.e. the supply rate) increases when the opening ratio is large, and the flow rate decreases when the opening ratio is small.

The control unit 12 is a computer having well-known RAM, ROM, and CPU. The control unit 12 is connected with the first to fourth opening-and-closing valves 17,18,19,20 and the first to fourth adjusting valves 26,27,28,29. The control unit 12 controls the opening ratios of the first to fourth adjusting valves 26,27,28,29 in order to increase and decrease the respective colorants B,R,Y,BL supplied to the coloring portion 10. The control unit 12 controls the whole wire coloring apparatus 1 by controlling the first to fourth opening-and-closing valves 17,18,19,20 and the first to fourth adjusting valves 26,27,28,29.

The control unit 12 has data of the mixing ratio of the colorants B,R,Y,BL for each color for the electric wire 3. And also, the control unit 12 has data of the opening ratio of the adjusting valves 26,27,28,29 for each color for the electric wire 3.

A non-shown input unit and the like are connected to the control unit 12. The operation condition of the wire coloring apparatus 1 can be set by the input unit. For example, the length and a specified color of the electric wire 3 are set by the input unit. Further, when the electric wire 3 is colored in a new color, the opening ratios of the respective adjusting valves 26,27,28,29 are given to the control unit 12 from the input unit.

When the electric wire 3 is colored by using the wire coloring apparatus 1, the operation condition (e.g. the length and a specified color of the electric wire 3) is firstly set by the input unit. The electric wire 3 is set on the roller 22a. The wire coloring apparatus 1 is started. The rollers 22a,22b rotate, and the electric wire 3 is moved toward the roller 22b from the roller 22a side.

The control unit opens the first to fourth opening-and-closing valves 17,18,19,20 on demand and controls the opening ratio of the first to fourth adjusting valves 26,27,28,29 according to the specified color of the outer surface 5a of the electric wire 3. The first to fourth colorants B,R,Y,BL are mixed in the mixing tank 23, and the mixed colorant is supplied to the sprayer 24. The coloring portion 10 of the wire coloring apparatus 1 colors the outer surface 5a (non-colored, i.e. in a color P as shown in FIG. 3A) of the electric wire 3 in the specified color Q over the whole periphery as shown with the hatching in FIGS. 1 and 3B.

When the electric wire 3 has been moved by a specified distance, which can be calculated from the number of rotation of the rollers 22a,22b for example, the spray of the mixed colorant from the sprayers is stopped. When the color for the electric wire 3 is changed, a solvent is firstly supplied to the mixing tank 23 from the solvent source, and the solvent is blown from the sprayers 24 so that the colorants B,R,Y,BL are removed from the mixing tank 23 and the sprayers 24. Subsequently, the control unit 12 changes the opening ratios of the adjusting valves 26,27,28,29 in order to change the mixing ratio of the colorants B,R,Y,BL to change the color for the outer surface 5a of the electric wire 3.

According to the present embodiment, the, first colorant B of blue, the second colorant R of red, the third colorant Y of yellow, and the fourth colorant BL of black are mixed in the mixing tank 23. Further, the control unit 12 changes the opening ratios of the adjusting valves 26,27,28,29 in order to change the mixing ratio of the colorants B,R,Y,BL. Like this, the color for the outer surface 5a of the electric wire 3 is changed. As above, the outer surface 5a of the electric wire 3 can be colored in every color only by preparing the four colorants B,R,Y,BL. Therefore, the facilities cost for coloring the electric wire 3 can be reduced.

The color for the outer surface 5a of the electric wire 3 can be easily changed only by changing the mixing ratio of the four colorants B,R,Y,BL. Therefore, the manufacturing efficiency of the electric wire 3 can be improved.

Further, because the outer surface 5a of the electric wire 3 can be colored in every color only by preparing the four colorants B,R,Y,BL, the trouble to order and stock-control the colorants B,R,Y,BL can be reduced, and the cost to convey and store the colorants B,R,Y,BL can be reduced. Therefore, the outer surface 5a of the electric wire 3 can be variously colored easily, and the cost of the electric wire 3 can be reduced.

In the above first embodiment, the first colorant B of blue, the second colorant R of red, the third colorant Y of yellow, and the fourth colorant BL of black are used. However, in the present invention, a plurality of colorants having respective colors different from each other can be used, not limited to blue, red, yellow, and black.

In this case, the colorants are received in the respective receiving tanks, and the flow rates of the colorants to the mixing tank 23 are adjusted by the increasing-and-decreasing means such as adjusting valves. The mixing ratio of the colorants is suitably changed in order to change the color for the outer surface 5a of the electric wire 3.

According to the above-described first embodiment, a wire coloring method and a wire coloring apparatus are obtained as follows. A wire coloring method, comprising the steps of: mixing colorants having respective colors different from each other; and coloring an outer surface of a non-colored electric wire, wherein a color for the outer surface of the electric wire is changed by changing a mixing ratio of the colorants. A wire coloring apparatus, comprising: a coloring portion to color an outer surface of an electric wire; receiving portions to receive respective colorants having respective colors different from each other and to supply the colorants to the coloring portion; a plurality of increasing-and-decreasing means to increase and decrease the respective colorants supplied from the respective receiving portions to the coloring portion; and a controlling means to control the plurality of increasing-and-decreasing means so as to increase and decrease the respective colorants supplied to the coloring portion, wherein the coloring portion mixes the colorants and colors the outer surface of the non-colored electric wire, and the controlling means changes a color for the outer surface of the electric wire by changing a mixing ratio of the colorants.

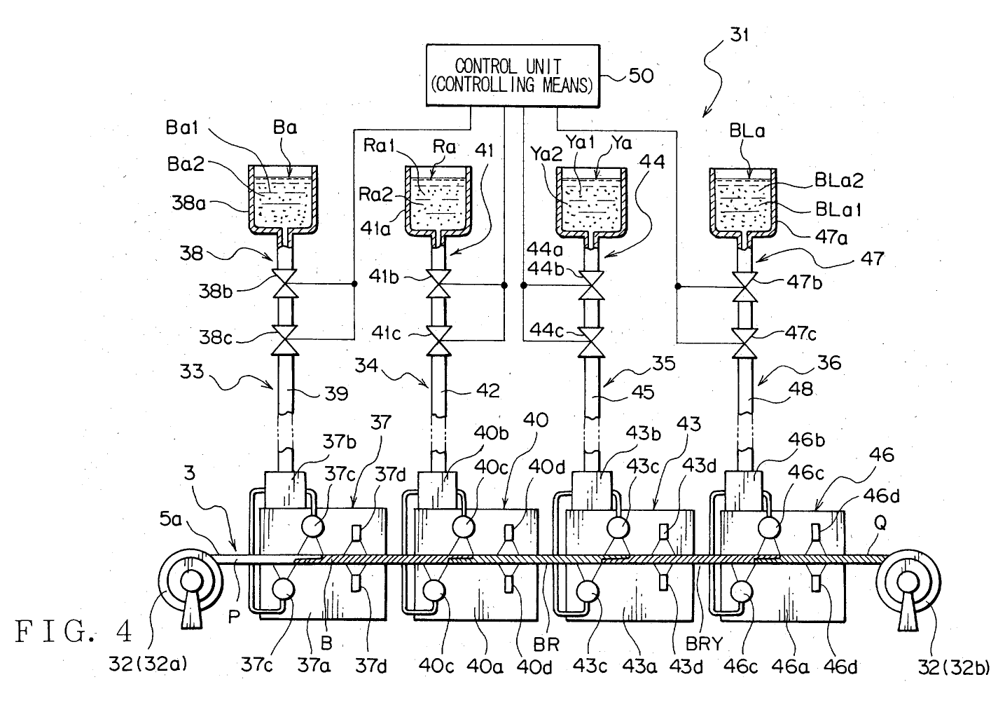

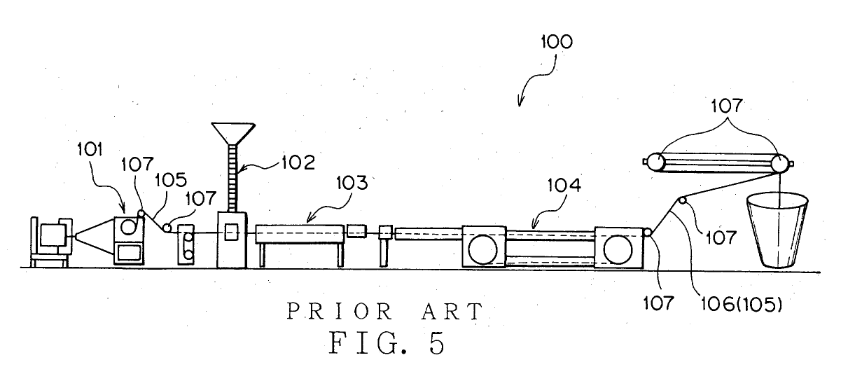

Next, a second embodiment of an inventive wire coloring apparatus 31 will be described with reference to FIG. 4. The wire coloring apparatus 31 is an apparatus which colors an outer surface 5a of an electric wire 3 in a specified color Q in a manner similar to the wire coloring apparatus 1 of the first embodiment.

The wire coloring apparatus 31 has a pair of rollers 32, a first coloring unit 33 as a first coloring portion, a second coloring unit 34 as a second coloring portion, a third coloring unit 35 as a third coloring portion, a fourth coloring unit 36 as a fourth coloring portion, and a control unit 50 as a controlling means, as shown in FIG. 4. The pair of rollers 32 are arranged with an interval with each other so that the electric wire 3 can be moved therebetween in a longitudinal direction of the electric wire 3. The left side roller 32(32a) in FIG. 4 is positioned upstream of a moving direction of the electric wire 3. The right side roller 32(32b) in FIG. 4 is positioned downstream of the moving direction of the electric wire 3.

The first coloring unit 33 has a coloring unit 37 and a coloring liquid supply portion 38. The coloring unit 37 has a unit body 37a, a receiver 37b, sprayers 37c and driers 37d. The unit body 37a is arranged between the rollers 32a,32b. The unit body 37a is arranged nearer the roller 32a.

The receiver 37b is formed in a box-shape and attached to the unit body 37a. First coloring liquid Ba is supplied from the coloring liquid supply portion 38 to the receiver 37b through a piping 39. The receiver 37b receives the first coloring liquid Ba once. The receiver 37b supplies the first coloring liquid Ba to the sprayers 37c.

In the illustrated embodiment, a pair of sprayers 37c are provided. The sprayers 37c are attached to the unit body 37a. The sprayer 37c sprays the first coloring liquid Ba on the electric wire 3 traveling between rollers 32a,32b. The sprayers 37c dye (color) the outer surface 5a of the electric wire 3 with the first coloring liquid Ba over the whole periphery of the electric wire 3. That is, the sprayers 37c color the outer surface 5a of the electric wire 3 with a colorant. The sprayers 37c color the outer surface 5a in a color, which is different from a color P of synthetic resin, over the whole periphery of the electric wire 3.

The driers 37d are attached to the unit body 37a and arranged downstream of the sprayers 37c in a moving direction of the electric wire 3. The drier 37d dries the coloring liquid sprayed on the outer surface 5a of the electric wire 3 by the sprayer 37c.

The coloring liquid supply portion 38 has a receiving tank 38a, an opening-and-closing valve 38b, and a first adjusting valve 38c as a first increasing-and-decreasing means. The receiving tank 38a is formed in a box-shape and receives the first coloring liquid Ba of blue. In the first coloring liquid Ba, a blue dye Ba1 is dissolved or dispersed in a solvent Ba2.

The first coloring liquid Ba of blue in the present specification means that the hue is blue, regardless of the lightness or the chroma (brightness). That is, the first coloring liquid Ba of blue in the present specification means that the hue is blue, regardless of light blue or-dark blue, or bright blue or dim blue. Here, the above hue means the tinge or the tint. The lightness is the degree of luminosity. The chroma is the degree of brightness.

The piping 39 is connected with the receiving tank 38a. The piping 39 is connected to the receiver 37b of the first coloring unit 33. The piping 39 leads the first coloring liquid Ba in the receiving tank 38a to the receiver 37b. The opening-and-closing valve 38b is attached to the piping 39. When the opening-and-closing valve 38b is open, the first coloring liquid Ba in the receiving tank 38a is supplied to the receiver 37b. When the opening-and-closing valve 38b is closed, the supply of the first coloring liquid Ba in the receiving tank 38a to the receiver 37b stops.

The first adjusting valve 38c is attached to the piping 39. The first adjusting valve 38c increases and decreases a flow rate of the first coloring liquid Ba from the receiving tank 38a to the receiver 37b by changing its opening ratio. That is, the first adjusting valve 38c increases and decreases the flow rate of the first coloring liquid Ba with which the first coloring unit 33 dyes the outer surface 5a of the electric wire 3. Of course, the flow rate (i.e. the supply rate) increases when the opening ratio is large, and the flow rate decreases when the opening ratio is small. As described, the first coloring unit 33 dyes the outer surface 5a of the electric wire 3 with the first coloring liquid Ba.

The second coloring unit 34 has a coloring unit 40 and a coloring liquid supply portion 41. The coloring unit 40 has a unit body 40a, a receiver 40b, sprayers 40c and driers 40d. The unit body 40a is arranged between the rollers 32a,32b. The unit body 40a is arranged next to the unit body 37a.

The receiver 40b is formed in a box-shape and attached to the unit body 40a. Second coloring liquid Ra is supplied from the coloring liquid supply portion 41 to the receiver 40b through a piping 42. The receiver 40b receives the second coloring liquid Ra once. The receiver 40b supplies the second coloring liquid Ra to the sprayers 40c.

In the illustrated embodiment, a pair of sprayers 40c are provided. The sprayers 40c are attached to the unit body 40a. The sprayer 40c sprays the second coloring liquid Ra on the electric wire 3 traveling between rollers 32a,32b. The sprayers 40c dye (color) the outer surface 5a of the electric wire 3 with the second coloring liquid Ra over the whole periphery of the electric wire 3. That is, the sprayers 40c color the outer surface 5a of the electric wire 3 with a colorant. The sprayers 40c color the outer surface 5a in a color, which is different from a color P of synthetic resin, over the whole periphery of the electric wire 3.

The driers 40d are attached to the unit body 40a and arranged downstream of the sprayers 40c in the moving direction of the electric wire 3. The drier 40d dries the coloring liquid sprayed on the outer surface 5a of the electric wire 3 by the sprayer 40c.

The coloring liquid supply portion 41 has a receiving tank 41a, an opening-and-closing valve 41b, and a second adjusting valve 41c as a second increasing-and-decreasing means. The receiving tank 41a is formed in a box-shape and receives the second coloring liquid Ra of red. In the second coloring liquid Ra, a red dye Ra1 is dissolved or dispersed in a solvent Ra2.

The second coloring liquid Ra of red in the present specification means that the hue is red, regardless of the lightness or the chroma (brightness). That is, the second coloring liquid Ra of red in the present specification means that the hue is red, regardless of light red or dark red, or bright red or dim red.

The piping 42 is connected with the receiving tank 41a. The piping 42 is connected to the receiver 40b of the second coloring unit 34. The piping 42 leads the second coloring liquid Ra in the receiving tank 41a to the receiver 40b. The opening-and-closing valve 41b is attached to the piping 42. When the opening-and-closing valve 41b is open, the second coloring liquid Ra in the receiving tank 41a is supplied to the receiver 40b. When the opening-and-closing valve 41b is closed, the supply of the second coloring liquid Ra in the receiving tank 41a to the receiver 40b stops.

The second adjusting valve 41c is attached to the piping 42. The second adjusting valve 41c increases and decreases a flow rate of the second coloring liquid Ra from the receiving tank 41a to the receiver 40b by changing its opening ratio. That is, the second adjusting valve 41c increases and decreases the flow rate of the second coloring liquid Ra with which the second coloring unit 34 dyes the outer surface 5a of the electric wire 3. Of course, the flow rate (i.e. the supply rate) increases when the opening ratio is large, and the flow rate decreases when the opening ratio is small. As described, the second coloring unit 34 dyes the outer surface 5a of the electric wire 3 with the second coloring liquid Ra.

The third coloring unit 35 has a coloring unit 43 and a coloring liquid supply portion 44. The coloring unit 43 has a unit body 43a, a receiver 43b, sprayers 43c and driers 43d. The unit body 43a is arranged between the rollers 32a,32b. The unit body 43a is arranged next to the unit body 40a.

The receiver 43b is formed in a box-shape and attached to the unit body 43a. Third coloring liquid Ya is supplied from the coloring liquid supply portion 44 to the receiver 43b through a piping 45. The receiver 43b receives the third coloring liquid Ya once. The receiver 43b supplies the third coloring liquid Ya to the sprayers 43c.

In the illustrated embodiment, a pair of sprayers 43c are provided. The sprayers 43c are attached to the unit body 43a. The sprayer 43c sprays the third coloring liquid Ya on the electric wire 3 traveling between rollers 32a,32b. The sprayers 43c dye (color) the outer surface 5a of the electric wire 3 with the third coloring liquid Ya over the whole periphery of the electric wire 3. That is, the sprayers 43c color the outer surface 5a of the electric wire 3 with a colorant. The sprayers 43c color the outer surface 5a in a color, which is different from a color P of synthetic resin, over the whole periphery of the electric wire 3.

The driers 43d are attached to the unit body 43a and arranged downstream of the sprayers 43c in the moving direction of the electric wire 3. The drier 43d dries the coloring liquid sprayed on the outer surface 5a of the electric wire 3 by the sprayer 43c.

The coloring liquid supply portion 44 has a receiving tank 44a, an opening-and-closing valve 44b, and a third adjusting valve 44c as a third increasing-and-decreasing means. The receiving tank 44a is formed in a box-shape and receives the third coloring liquid Ya of yellow. In the third coloring liquid Ya, a yellow dye Ya1 is dissolved or dispersed in a solvent Ya2.

The third coloring liquid Ya of yellow in the present specification means that the hue is yellow, regardless of the lightness or the chroma (brightness). That is, the third coloring liquid Ya of yellow in the present specification means that the hue is yellow, regardless of light yellow or dark yellow, or bright yellow or dim yellow.

The piping 45 is connected with the receiving tank 44a. The piping 45 is connected to the receiver 43b. The piping 45 leads the third coloring liquid Ya in the receiving tank 44a to the receiver 43b. The opening-and-closing valve 44b is attached to the piping 45. When the opening-and-closing valve 44b is open, the third coloring liquid Ya in the receiving tank 44a is supplied to the receiver 43b. When the opening-and-closing valve 44b is closed, the supply of the third coloring liquid Ya in the receiving tank 44a to the receiver 43b stops.

The third adjusting valve 44c is attached to the piping .45. The third adjusting valve 44c increases and decreases a flow rate of the third coloring liquid Ya from the receiving tank 44a to the receiver 43b by changing its opening ratio. That is, the third adjusting valve 44c increases and decreases the flow rate of the third coloring liquid Ya with which the third coloring unit 35 dyes the outer surface 5a of the electric wire 3. Of course, the flow rate (i.e. the supply rate) increases when the opening ratio is large, and the flow rate decreases when the opening ratio is small. As described, the third coloring unit 35 dyes the outer surface 5a of the electric wire 3 with the third coloring liquid Ya.

The fourth coloring unit 36 has a coloring unit 46 and a coloring liquid supply portion 47. The coloring unit 46 has a unit body 46a, a receiver 46b, sprayers 46c and driers 46d. The unit body 46a is arranged between the rollers 32a,32b. The unit body 46a is arranged next to the unit body 43a and near the roller 32b. As above, the first to fourth coloring units 33,34,35,36 are lined up along the electric wire 3 from the upstream side to the downstream side thereof.

The receiver 46b is formed in a box-shape and attached to the unit body 46a. Fourth coloring liquid BLa is supplied from the coloring liquid supply portion 47 to the receiver 46b through a piping 48. The receiver 46b receives the fourth coloring liquid BLa once. The receiver 46b supplies the fourth coloring liquid BLa to the sprayers 46c.

In the illustrated embodiment, a pair of sprayers 46c are provided. The sprayers 46c are attached to the unit body 46a. The sprayer 46c sprays the fourth coloring liquid BLa on the electric wire 3 traveling between rollers 32a,32b. The sprayers 46c dye (color) the outer surface 5a of the electric wire 3 with the fourth coloring liquid BLa over the whole periphery of the electric wire 3. That is, the sprayers 46c color the outer surface 5a of the electric wire 3 with a colorant. The sprayers 46c color the outer surface 5a in a color Q, which is different from a color P of synthetic resin, over the whole periphery of the electric wire 3.

The driers 46d are attached to the unit body 46a and arranged downstream of the sprayers 46c in the moving direction of the electric wire 3. The drier 46d dries the coloring liquid sprayed on the outer surface 5a of the electric wire 3 by the sprayer 46c.

The coloring liquid supply portion 47 has a receiving tank 47a, an opening-and-closing valve 47b, and a fourth adjusting valve 47c as a fourth increasing-and-decreasing means. The receiving tank 47a is formed in a box-shape and receives the fourth coloring liquid BLa of black. In the fourth coloring liquid BLa, a black dye BLa1 is dissolved or dispersed in a solvent BLa2.

The fourth coloring liquid BLa of black in the present specification means that the hue is black, regardless of the lightness. That is, the fourth coloring liquid BLa of black in the present specification means that the hue is black, regardless of light black or dark black.

The piping 48 is connected with the receiving tank 47a. The piping 48 is connected to the receiver 46b. The piping 48 leads the fourth coloring liquid BLa in the receiving tank 47a to the receiver 46b. The opening-and-closing valve 47b is attached to the piping 48. When the opening-and-closing valve 47b is open, the fourth coloring liquid BLa in the receiving tank 47a is supplied to the receiver 46b. When the opening-and-closing valve 47b is closed, the supply of the fourth coloring liquid BLa in the receiving tank 47a to the receiver 46b stops.

The fourth adjusting valve 47c is attached to the piping 48. The fourth adjusting valve 47c increases and decreases a flow rate of the fourth coloring liquid BLa from the receiving tank 47a to the receiver 46b by changing its opening ratio. That is, the fourth adjusting valve 47c increases and decreases the flow rate of the fourth coloring liquid BLa with which the fourth coloring unit 36 dyes the outer surface 5a of the electric wire 3. Of course, the flow rate (i.e. the supply rate) increases when the opening ratio is large, and the flow rate decreases when the opening ratio is small. As described, the fourth coloring unit 36 dyes the outer surface 5a of the electric wire 3 with the fourth coloring liquid BLa.

The control unit 50 is a computer having well-known RAM, ROM, and CPU. The control unit 50 is connected with the first to fourth opening-and-closing valves 38b,41b,44b,47b and the first to fourth adjusting valves 38c,41c,44c,47c. The control unit 50 controls the opening ratios of the first to fourth adjusting valves 38c,41c,44c,47c in order to increase and decrease the respective coloring liquids Ba,Ra,Ya,BLa supplied to the respective receivers 37b,40b,43b,46b. The control unit 50 controls the whole wire coloring apparatus 31 by controlling the first to fourth opening-and-closing valves 38b,41b,44b,47b and the first to fourth adjusting valves 38c,41c,44c,47c.

The control unit 50 has data of the amount of the coloring liquids Ba,Ra,Ya,BLa for each color for the electric wire 3. And also, the control unit 50 has data of the opening ratio of the adjusting valves 38c,41c,44c,47c for each color for the electric wire 3.

A non-shown input unit and the like are connected to the control unit 50. The operation condition of the wire coloring apparatus 31 can be set by the input unit. For example, the length and a specified color of the electric wire 3 are set by the input unit. Further, when the electric wire 3 is colored in a new color, the opening ratios of the respective adjusting valves 38c,41c,44c,47c are given to the control unit 50 from the input unit.

When the electric wire 3 is colored by using the wire coloring apparatus 31, the operation condition (e.g. the length and a specified color of the electric wire 3) is firstly set by the input unit. The electric wire 3 is set on the roller 32a. The wire coloring apparatus 31 is started. The rollers 32a,32b rotate, and the electric wire 3 is moved toward the roller 32b from the roller 32a side.

The control unit opens the first to fourth opening-and-closing valves 38b,41b,44b,47b on demand and controls the opening ratio of the first to fourth adjusting valves 38c,41c,44c,47c according to the specified color of the outer surface 5a of the electric wire 3. The outer surface 5a of the electric wire 3 is firstly dyed (colored) by the first coloring unit 33. That is, the first coloring unit 33 dyes the non-colored outer surface 5a (color P) of the electric wire 3 in blue B (FIG. 4).

Secondly, the second coloring unit 34 dyes the outer surface 5a (of color B) of the electric wire 3 with the second coloring liquid Ra of red in a color BR (FIG. 4). The third coloring unit 35 dyes the outer surface 5a (of color BR) of the electric wire 3 with the third coloring liquid Ya of yellow in a color BRY (FIG. 4). The fourth coloring unit 36 dyes the outer surface 5a (of color BRY) of the electric wire 3 with the fourth coloring liquid BLa of black in the specified color Q (FIG. 4).

When the electric wire 3 has been moved by a specified distance, which can be calculated from the number of rotation of the rollers 32a,32b for example, the spray of the coloring liquids Ba,Ra,Ya,BLa from the sprayers 37c,40c,43c,46c is stopped.

The outer surface 5a of the electric wire 3 is dyed (colored) in turn, or successively, with the first coloring liquid Ba of blue, the second coloring liquid Ra of red, the third coloring liquid Ya of yellow, and the fourth coloring liquid BLa of black, while moving the electric wire 3. The color of the outer surface 5a of the electric wire 3 is changed by increasing and decreasing the amount of each of the coloring liquids Ba,Ra,Ya,BLa. As above, the outer surface 5a of the electric wire 3 can be colored in every color only by preparing the four coloring liquids Ba,Ra,Ya,BLa. Therefore, the facilities cost for coloring the electric wire 3 can be reduced.

The color for the outer surface 5a of the electric wire 3 can be easily changed only by changing the amount of each of the four coloring liquids B,R,Y,BL. Therefore, the manufacturing efficiency of the electric wire 3 can be improved.

Further, because the outer surface 5a of the electric wire 3 can be colored in every color only by preparing the four coloring liquids Ba,Ra,Ya,BLa, the trouble to order and stock-control the coloring liquids Ba,Ra,Ya,BLa can be reduced, and the cost to convey and store the coloring liquids Ba,Ra,Ya,BLa can be reduced. Therefore, the outer surface 5a of the electric wire 3 can be variously colored easily, and the cost of the electric wire 3 can be reduced.

The outer surface 5a of the electric wire 3 is dyed (colored) in turn with the first to fourth coloring liquids Ba,Ra,Ya,BLa. That is, it is not necessary to dye (color) the electric wire 3 in the specified color Q at a time. Therefore, the electric wire 3 can be dyed (colored) in the specified color Q by dying it with the coloring liquids Ba,Ra,Ya,BLa one by one with a time interval of, for example, several hours or several days. Therefore, limitation of the process for coloring the electric wire 3 can be relaxed, thereby increasing the degree of freedom of the coloring process.

The first to fourth coloring units 33,34,35,36 are lined up along the moving direction of the electric wire 3. Therefore, the outer surface 5a of the electric wire 3 can be securely dyed successively with the first coloring liquid Ba of blue, the second coloring liquid Ra of red, the third coloring liquid Ya of yellow, and the fourth coloring liquid BLa of black. Therefore, the outer surface 5a of the electric wire 3 can be securely colored in every color.

In the above second embodiment, the first coloring liquid Ba of blue, the second coloring liquid Ra of red, the third coloring liquid Ya of yellow, and the fourth coloring liquid BLa of black are used. However, in the present invention, a plurality of coloring liquids having respective colors different from each other can be used, not limited to blue, red, yellow, and black.

In this case, the coloring liquids are received in the respective receiving tanks, and the flow rates of the coloring liquids to the receivers are adjusted by the increasing-and-decreasing means such as adjusting valves. The amount of each coloring liquid is suitably changed in order to change the color for the outer surface 5a of the electric wire 3.

According to the above-described second embodiment, a wire coloring method and a wire coloring apparatus are obtained as follows. A wire coloring method, comprising the step of: coloring an outer surface of a non-colored electric wire by dyeing the outer surface of the electric wire in turn with coloring liquids having respective colors different from each other, wherein a color for the outer surface of the electric wire is changed by increasing and decreasing each of the coloring liquids. A wire coloring apparatus, comprising: coloring portions to dye an outer surface of an electric wire with respective coloring liquids having respective colors different from each other; a plurality of increasing-and-decreasing means to increase and decrease the respective coloring liquids, to dye the outer surface of the electric wire, to the respective coloring portions; and a controlling means to control the plurality of increasing-and-decreasing means so as to increase and decrease the respective coloring liquids to the respective coloring portions, wherein an outer surface of a non-colored electric wire is colored by dyeing the outer surface of the electric wire in turn with the coloring liquids having respective colors different from each other, and a color for the outer surface of the electric wire is changed by increasing and decreasing each of the coloring liquids by the controlling means.

The above-described embodiment is for the electric wire 3 forming the wiring harness arranged on a motor vehicle. However, the electric wire 3 manufactured by the inventive manufacturing method is not limited to a vehicle use and can be used for electronic equipment such as a portable computer and for various electric machines.

In the present invention, various wire coloring means such as dipping, atomization, injection, printing, and transcription may be used. Further, the coloring liquid or the paint such as acrylic paint, ink (dye series and pigment series), and the like may be used.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A wire coloring method, comprising the steps of:
mixing colorants having respective colors different from each other; and
coloring an outer surface of a non-colored electric wire,
wherein a color for the outer surface of the electric wire is changed by changing a mixing ratio of the colorants.

2. A wire coloring method, comprising the steps of:
mixing a first colorant of blue, a second colorant of red, a third colorant of yellow, and a fourth colorant of black; and
coloring an outer surface of a non-colored electric wire,
wherein a color for the outer surface of the electric wire is changed by changing a mixing ratio of the first to fourth colorants.

3. A wire coloring apparatus, comprising:
a coloring portion to color an outer surface of an electric wire;
receiving portions to receive respective colorants having respective colors different from each other and to supply the colorants to the coloring portion;
a plurality of increasing-and-decreasing means to increase and decrease the respective colorants supplied from the respective receiving portions to the coloring portion; and
a controlling means to control the plurality of increasing-and-decreasing means so as to increase and decrease the respective colorants supplied to the coloring portion,
wherein the coloring portion mixes the colorants and colors the outer surface of the non-colored electric wire, and the controlling means changes a color for the outer surface of the electric wire by changing a mixing ratio of the colorants.

4. A wire coloring apparatus, comprising:
a coloring portion to color an outer surface of an electric wire;
a first receiving portion to receive a first colorant of blue and to supply the first colorant to the coloring portion;
a second receiving portion to receive a second colorant of red and to supply the second colorant to the coloring portion;
a third receiving portion to receive a third colorant of yellow and to supply the third colorant to the coloring portion;
a fourth receiving portion to receive a fourth colorant of black and to supply the fourth colorant to the coloring portion;
a first increasing-and-decreasing means to increase and decrease a first colorant supplied from the first receiving portion to the coloring portion;
a second increasing-and-decreasing means to increase and decrease a second colorant supplied from the second receiving portion to the coloring portion;
a third increasing-and-decreasing means to increase and decrease a third colorant supplied from the third receiving portion to the coloring portion;
a fourth increasing-and-decreasing means to increase and decrease a fourth colorant supplied from the fourth receiving portion to the coloring portion; and
a controlling means to control the first to fourth increasing-and-decreasing means so as to increase and decrease the respective colorants supplied to the coloring portion,
wherein the coloring portion mixes the first to fourth colorants and colors the outer surface of the non-colored electric wire, and the controlling means changes a color for the outer surface of the electric wire by changing a mixing ratio of the first to fourth colorants.

5. A wire coloring method, comprising the step of:
coloring an outer surface of a non-colored electric wire by dyeing the outer surface of the electric wire in turn with coloring liquids having respective colors different from each other,
wherein a color for the outer surface of the electric wire is changed by increasing and decreasing each of the coloring liquids.

6. A wire coloring method, comprising the step of:
coloring an outer surface of a non-colored electric wire by dyeing the outer surface of the electric wire with a first coloring liquid of blue, a second coloring liquid of red, a third coloring liquid of yellow, and a fourth coloring liquid of black,
wherein a color for the outer surface of the electric wire is changed by increasing and decreasing each of the first to fourth coloring liquids.

7. A wire coloring apparatus, comprising:
coloring portions to dye an outer surface of an electric wire with respective coloring liquids having respective colors different from each other;
a plurality of increasing-and-decreasing means to increase and decrease the respective coloring liquids, to dye the outer surface of the electric wire, to the respective coloring portions; and
a controlling means to control the plurality of increasing-and-decreasing means so as to increase and decrease the respective coloring liquids to the respective coloring portions,
wherein an outer surface of a non-colored electric wire is colored by dyeing the outer surface of the electric wire in turn with the coloring liquids having respective colors different from each other, and a color for the outer surface of the electric wire is changed by increasing and decreasing each of the coloring liquids by the controlling means.

8. A wire coloring apparatus, comprising:
a first coloring portion to dye an outer surface of an electric wire with a first coloring liquid of blue;
a second coloring portion to dye the outer surface of the electric wire with a second coloring liquid of red;
a third coloring portion to dye the outer surface of the electric wire with a third coloring liquid of yellow;
a fourth coloring portion to dye the outer surface of the electric wire with a fourth coloring liquid of black;
a first increasing-and-decreasing means to increase and decrease the first coloring liquid, to dye the outer surface of the electric wire, to the first coloring portion;
a second increasing-and-decreasing means to increase and decrease the second coloring liquid, to dye the outer surface of the electric wire, to the second coloring portion;
a third increasing-and-decreasing means to increase and decrease the third coloring liquid, to dye the outer surface of the electric wire, to the third coloring portion;
a fourth increasing-and-decreasing means to increase and decrease the fourth coloring liquid, to dye the outer surface of the electric wire, to the fourth coloring portion; and
a controlling means to control the first to fourth increasing-and-decreasing means so as to increase and decrease the respective coloring liquids to the first to fourth coloring portions,
wherein an outer surface of a non-colored electric wire is colored by dyeing the outer surface of the electric wire with the first to fourth coloring liquids, and a color for the outer surface of the electric wire is changed by increasing and decreasing each of the first to fourth coloring liquids by the controlling means.

9. The wire coloring apparatus as set forth in claim 8, wherein the electric wire is moved in its longitudinal direction, the first to fourth coloring portions are arranged in the moving direction of the electric wire, and the coloring portions color the outer surface of the electric wire being moving in turn.
